(19) United States
(12) Patent Application Publication
(10) Pub. No.: US 2026/0051969 A1
(43) Pub. Date: Feb. 19, 2026

(54) METHOD AND APPARATUS FOR CROSS-NETWORK CONVERGED TRANSMISSION BASED ON NETWORK CODING

(71) Applicant: BEIJING JIAOTONG UNIVERSITY, Beijing (CN)

(72) Inventors: Wei QUAN, Beijing (CN); Yuming ZHANG, Beijing (CN); Yirong ZHUANG, Beijing (CN); Mingyuan LIU, Beijing (CN); Bo LEI, Beijing (CN); Jinfa WANG, Beijing (CN); Jun DENG, Beijing (CN); Yuguo SHAN, Beijing (CN); Peizhe WANG, Beijing (CN); Xiaoxiao YU, Beijing (CN); Wei SU, Beijing (CN); Hongke ZHANG, Beijing (CN)

(21) Appl. No.: 18/987,921

(22) Filed: Dec. 19, 2024

(30) Foreign Application Priority Data
Aug. 15, 2024 (CN) 202411120835.0

(51) Int. Cl. H04L 1/00; H04L 1/1825

(52) U.S. Cl. CPC H04L 1/0011; H04L 1/0027; H04L 1/1825

(57) ABSTRACT

The present application provides a method and apparatus for cross-network converged transmission based on network coding and relates to the field of communication technologies. The method initially includes selecting an encoding method based on an application type and encoding original packets to obtain a plurality of to-be-transmitted packets. A network status is obtained and a scheduling scheme is determined based on the network status. Weights of links for transmitting the plurality of to-be-transmitted packets are adjusted based on the scheduling scheme. In the present application, the encoding method is selected based on the application type such that cross-network converged transmission can be completed based on network coding. This reduces latency while improving data transmission bandwidth.

### CROSS REFERENCE TO RELATED APPLICATION

This patent application claims the benefit and priority of Chinese Patent Application No. 202411120835.0, filed with the China National Intellectual Property Administration on Aug. 15, 2024, the disclosure of which is incorporated by reference herein in its entirety as part of the present application.

### TECHNICAL FIELD

The present application relates to the field of communication technologies, and in particular, to a method and apparatus for cross-network converged transmission based on network coding.

### BACKGROUND

In smart city construction, a network architecture centered on cloud computing is main research content. At present, data transmission is performed through a single network standard. A mobile communication device is prone to signal loss and connection rate limitation when operating to a dead zone of the network standard. A radio link is vulnerable to frequent emergencies, unreliable and unpredictable. Different types of applications have different requirements for reliability and latency. A uniform encoding method adopted before data transmission cannot meet these requirements.

### SUMMARY

An objective of the present application is to provide a method and apparatus for cross-network converged transmission based on network coding. Cross-network converged transmission can be completed based on network coding. This reduces latency while improving data transmission bandwidth.

To achieve the foregoing objective, the present application provides the following solutions:

The present application provides a method for cross-network converged transmission based on network coding, including:
selecting an encoding method based on an application type and encoding original packets to obtain a plurality of to-be-transmitted packets, where the to-be-transmitted packets include encoded packets and redundant packets;
obtaining a network status;
determining a scheduling scheme based on the network status; and
adjusting, based on the scheduling scheme, weights of links for transmitting the plurality of to-be-transmitted packets.

An apparatus for cross-network converged transmission based on network coding is provided. The apparatus is applied to a smart city system. The system includes a transmit end and a receive end. The transmit end transmits a plurality of to-be-transmitted packets to the receive end through a plurality of links.

The apparatus includes a network status detection module, a network coding module, and a cross-network converged scheduling module that are integrated at the transmit end.

The cross-network converged scheduling module is connected to the network status detection module and the network coding module.

The network coding module is configured to select an encoding method based on an application type and encode original packets to obtain a plurality of to-be-transmitted packets.

The network status detection module is configured to obtain a network status.

The cross-network converged scheduling module is configured to determine a scheduling scheme based on the network status, and adjust, based on the scheduling scheme, weights of links for transmitting the plurality of to-be-transmitted packets.

The network coding module includes a protocol construction module, a redundancy adjustment module, an encoding method selection module, and a parsing module, a buffer module, a encoding module, and a forwarding module that are sequentially connected.

The protocol construction module, the redundancy adjustment module, and the encoding method selection module each are connected to the encoding module.

The cross-network converged scheduling module includes a weight adjustment module and a forwarding scheduling module.

The forwarding scheduling module is connected to the forwarding module and the weight adjustment module.

The weight adjustment module is connected to the network status detection module.

According to specific embodiments provided in the present application, the present application discloses the following technical effects:

In the present application, a programmable switch is used to make it possible to construct a network coding data plane. A quantity of packets processed by a chip of the programmable switch per second is increased such that network coding throughput is improved. To improve performance of the present application applied to a smart city, the encoding method is selected in the encoding module based on the application type to optimize the encoding method. The cross-network converged scheduling module selects an optimal scheduling path based on detected network status information to ensure fastest transmission of packets to the receive end.

### BRIEF DESCRIPTION OF THE DRAWINGS

To describe the embodiments of the present application or the technical solutions in the prior art more clearly, the accompanying drawings required in the embodiments will be briefly introduced below.

FIG. 1 is a module diagram of a cross-network converged transmission apparatus;

FIG. 2 is a principle diagram of a cross-network converged transmission apparatus;

FIG. 3 is a schematic diagram of a packet format for a network status detection module;

FIG. 4 is a schematic diagram of parsing a packet header by a network status detection module;

FIG. 5 is a schematic diagram of collecting information by a network status detection module;

FIG. 6 is a schematic diagram of a format of an Internet Protocol (IP) network coding packet header;

FIG. 7 is a schematic diagram of parsing a packet header by a network coding module;

FIG. 8 is a schematic diagram of a network coding buffer module;

FIG. 9 is a schematic diagram of a network coding module and a cross-network converged scheduling module;

FIG. 10 is a schematic diagram of random linear network coding;

FIG. 11 is a schematic diagram of increased throughput network coding; and

FIG. 12 is a principle diagram of a cross-network converged transmission method.

### DETAILED DESCRIPTION OF THE EMBODIMENTS

### Embodiment 1

This embodiment discloses an apparatus for cross-network converged transmission based on network coding applied to a smart city system. The system includes a transmit end and a receive end. The transmit end transmits a plurality of to-be-transmitted packets to the receive end through a plurality of links.

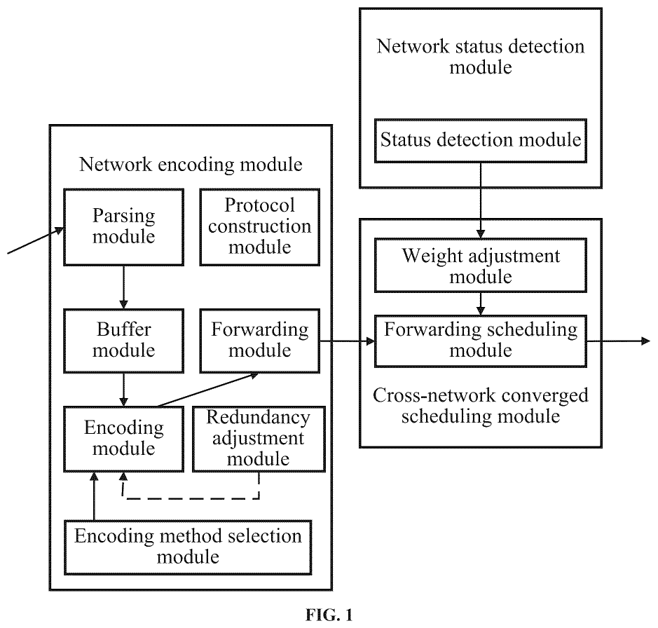

As shown in FIG. 1, the apparatus includes a network status detection module, a network coding module, and a cross-network converged scheduling module that are integrated at the transmit end. The network coding module includes a protocol construction module, a redundancy adjustment module, an encoding method selection module, and a parsing module, a buffer module, a encoding module, and a forwarding module that are sequentially connected. The protocol construction module, the redundancy adjustment module, and the encoding method selection module each are connected to the encoding module.

The network status detection module has only one functional module, namely a status detection module, which mainly performs fine-grained monitoring on network traffic such that the module can collect data at various points within a network, including an individual switch and router. This module constructs and parses a network status detection packet to sense a network status, including latency, bandwidth, and a packet loss rate, only through a few packets.

The network coding module mainly includes seven functional modules: the protocol construction module, the redundancy adjustment module, the encoding method selection module, and the parsing module, the buffer module, the encoding module, and the forwarding module that are sequentially connected. An increased throughput network coding method in the network coding module can ensure low-latency transmission of application services with strict validity periods, such as video streams. A random linear network coding method ensures transmission reliability by increasing redundancy, and effectively reduces additional latency due to network coding by adjusting encoding redundancy. The protocol construction module and the parsing module add information required for encoding and decoding to the packet. The buffer module buffers the collected packets. When a period of time passes or enough packets are collected, the encoding method selection module selects a corresponding encoding method to encode the packets. The random linear network coding module generates different encoding vectors by utilizing a multicast mode of the forwarding module, to obtain encoded packets and redundant packets. The redundancy adjustment module adjusts a quantity of redundant packets to improve encoding performance. In the increased throughput network coding method, exclusive OR (XOR) processing is directly performed on the packets to form one packet for forwarding. Because there is only one packet, the forwarding scheduling module selects an optimal link to a next-hop switch or terminal based on a weight.

The cross-network converged scheduling module mainly includes two functional modules: the weight adjustment module and the forwarding scheduling module. The network status detection module obtains information sensed for a link, adjusts an estimated status of the link, and then adjusts a weight of the link accordingly. The forwarding scheduling module transmits a corresponding quantity of packets based on the weight of the link, to ensure low latency and high reliability for applications.

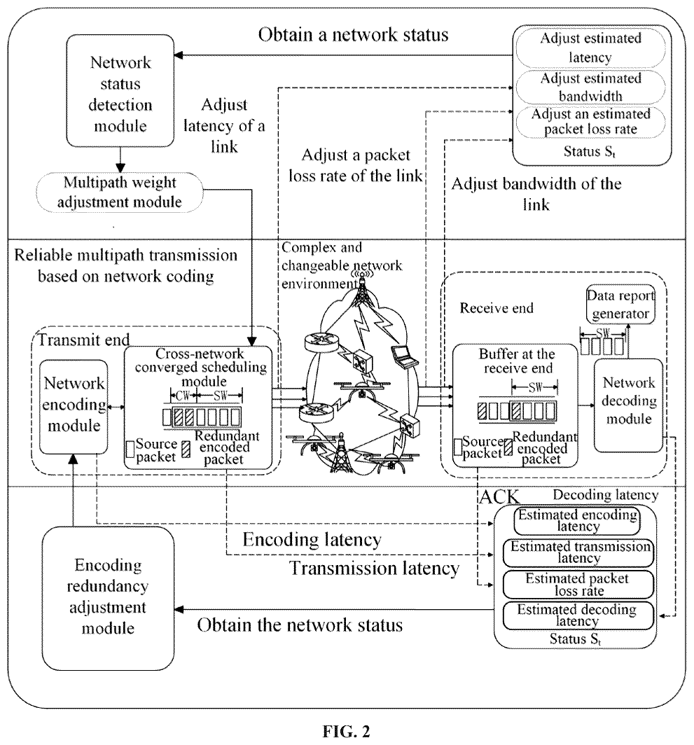

As shown in FIG. 2, specific functional modules and a implementation procedure of the method when the transmit end transmits data are as follows:

Cross-network converged transmission between the transmit end and the receive end in a radio environment involves a plurality of paths. At the transmit end, the network status detection module senses each link through an in-band network telemetry (INT) technology, and adjusts estimated latency, estimated bandwidth, an estimated packet loss rate, and the like based on the measured link status. The network coding module can establish a mathematical model for encoding and decoding latency and transmission latency and set an optimization objective accordingly to adjust encoding redundancy. In this way, random linear network coding is performed to ensure reliability. In addition, the network coding module selects different encoding methods based on different application types to achieve high-reliability or low-latency transmission. The weight of each link is adjusted based on the status of the plurality of links from the network status detection module to ensure that the packets can arrive at the receive end with low latency and high reliability.

The receive end includes encoded packets and redundant packets arriving at the receive end in addition to a receive buffer. The receive end decodes the encoded packets based on their encoding coefficients to obtain a payload of original packets, or listens to and immediately decodes at least one received encoded packet obtained after increased throughput network coding is performed. In addition, the receive end encapsulates decoded data, and delivers encapsulated data to an upper-layer application through a data report generator. The following describes a role and function of each module in a method for cross-network converged transmission based on network coding by describing a process of forwarding a packet from the transmit end to the receive end in detail.

When the transmit end, namely a programmable switch, receives a packet, an extra encoded packet header is added, and a corresponding encoding method is selected based on an application type. The random linear network coding module determines the encoding redundancy, namely a proportion of added redundant packets to original packets, based on estimated encoding and decoding latency and transmission latency, to minimize network coding latency and improve reliability. Although redundant packets increase an amount of data sent, they ensure that enough packets arrive at the receive end, accelerating a encoding process and minimizing retransmissions. During increased throughput network coding, specific packets are selected for XOR processing and transmission. Data of the upper-layer application is divided into data blocks with a same length. The data blocks are encapsulated into packets with the same length for encoding. Other types of packets are not subjected to any operations by the network coding module and are usually forwarded directly.

The network status detection module constructs custom packets, which are standard network traffic packets with special headers for collecting INT information introduced. The headers include parameters to be monitored. Then, the constructed INT packets are periodically sent to a network. When the INT packets pass through a network device, the programmable switch parses the INT headers and performs operations based on information therein, such as writing latency and a quantity of packets to the headers of the packets. When the packets arrive at the receive end, data information is collected and shows latency, bandwidth, and the like. The cross-network converged scheduling module updates maintained status metrics based on network status information collected by the network status detection module, such as latency, bandwidth, and a packet loss rate, predicts status information of a next link, and adjusts, based on the status information, the weight of each link for transmitting packets such that a path for forwarding packets is selected based on the weight.

At the receive end, the packets are first stored in the receive buffer. A random linear network decoder decodes the collected packets based on encoding vectors of headers of the packets and a payload after encoding, and extracts original packets. Then, data is passed to the upper-layer application through the data report generator. Random linear network coding ensures reliability. A connection adopted in the present application is unreliable. A lost packet is not automatically retransmitted to ensure that a redundant lost packet is not retransmitted. If decoding fails, a feedback strategy may be adopted and a time threshold may be set. When a decoding time exceeds the threshold, the receive end sends a feedback packet to inform the transmit end to adopt a retransmission strategy. For encoded packets obtained after increased throughput network coding is performed, the receive end listens to and immediately decodes received packets and discards undecodable packets to reduce computational latency.

In the network status detection module:

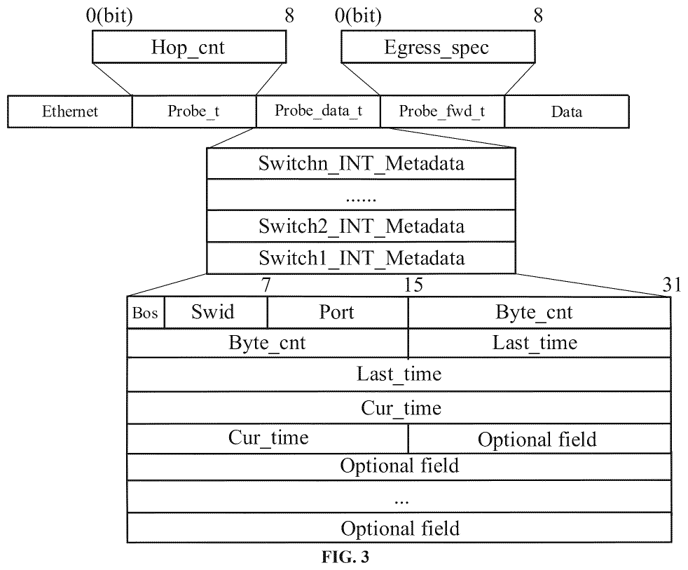

Packet headers are mainly located after an Ethernet frame, as shown in FIG. 3. The headers mainly include probe t, probe_data_t, and probe_fwd_t. The probe_t header provides a mechanism for tracing a transmission path of a packet in a network. By recording a quantity of hops through which a packet passes, an administrator can learn how the packet travels in the network and a path length, and assess complexity and performance of a network topology. The probe_data_t header carries additional monitoring information to help the administrator monitor and analyze network performance and status. The information may include an identity of each network node through which the packet passes, traffic load, actual traffic data, a transmission time of the packet in the network, and the like, to help the administrator quickly identify and resolve problems in the network. The probe_fwd_t header indicates an egress port to which a next node should send the packet, to guide the transmission path of the packet in the network. This header can ensure that the packet is transmitted along an expected path and can reach its destination, to finally achieve comprehensive monitoring and management of network performance and status, while ensuring that status information of a corresponding link can be measured.

Fields in the packet headers of the network status detection module are described in detail, mainly including 3 headers and 8 fields. The fields mainly include a field that indicates a quantity of hops for passing through a switch, a field that indicates an identifier of the switch, a field that indicates an egress port, and the like. Table 1 shows meanings and functions of the fields.

TABLE 1
Meanings of INT packet header fields

| INT packet | | Field | |
|---|---|---|---|
| header field | Position | length | Function |
| Hop_cnt | Probe_t | 8 bit | Indicates a quantity of hops through which a |
| | | | probe packet has passed. A value of this field |
| | | | increments each time the probe packet passes |
| | | | through a network node. |
| Bos | Probe_data_t | 1 bit | Indicates an end of the probe packet. In the |
| | | | probe packet, there may be a plurality of data |
| | | | parts, each of which records the probe packet's |
| | | | journey in a switch. If this field is set to 1, it |
| | | | is the last data part of the probe packet and no |
| | | | more data part follows it. |
| Swid | Probe_data_t | 7 bit | Indicates an identifier of a switch for which this |
| | | | header is added. An identity of each network |
| | | | node through which the packet passes can be |
| | | | determined through this field. |
| Port | Probe_data_t | 8 bit | Indicates which port of the switch the packet |
| | | | exits from. Traffic load and utilization of each |
| | | | port can be assessed by recording the egress |
| | | | port. |
| Byte_cnt | Probe_data_t | 32 bit | Indicates a quantity of bytes transmitted through |
| | | | the port since a previous probe packet. This field |
| | | | can be used to assess actual traffic for each port. |
| Last_time | Probe_data_t | 48 bit | Indicates when the previous probe packet passes |
| | | | through the port. |
| Cur_time | Probe_data_t | 48 bit | Indicates when a current probe packet passes |
| | | | through the port. |
| Egress_spec | Probe_fwd_t | 8 bit | Indicates an egress port to which the switch |
| | | | should send the probe packet. |

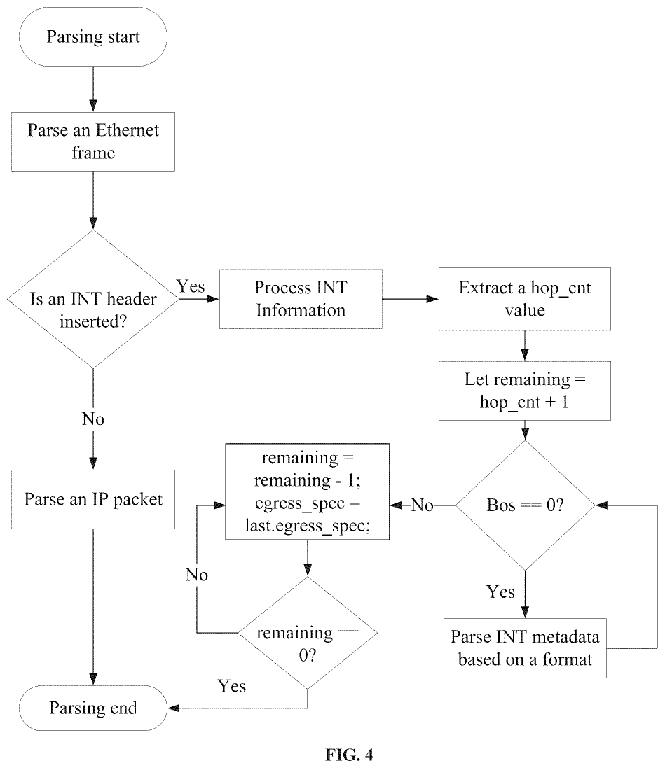

The following describes a specific procedure of network status detection. Network status detection in the present application is mainly designed based on a programmable switch and a high-level language P4 for programming the programmable switch. FIG. 4 shows a packet parsing procedure for the network status detection module. First, a parser processes a packet. The parser distributes the packet to a corresponding processing procedure based on an EtherType field in an Ethernet frame. If the EtherType field indicates a specific probe type (0x0812), the packet is sent to a probe packet parsing procedure. If the packet is identified as a probe packet, the switch is responsible for extracting probe packet header information from the packet and setting a remaining hop count to a count value of a hop counter (hop_cnt) plus 1 for subsequent use. When parsing a data part of the probe packet (in a parse_probe_data state), the parser extracts a next piece of probe data (probe_data) and chooses to enter a next state based on a last flag bit (bos) of the probe data. If the flag bit is 1, this is the last data part of the probe packet and the parser starts to parse egress forwarding (in a parse_probe_fwd state). Otherwise, the parser continues to parse a next data part of the probe packet. The parser chooses to enter the next state through state transition based on the remaining hop count of the current probe packet. Each time egress forwarding of the probe packet is parsed (in the parse_probe_fwd state), the remaining hop count is reduced by 1. If the remaining hop count is 0, the egress forwarding of the probe packet has been parsed and a parsing process ends. Otherwise, the egress forwarding of the probe packet continues to be parsed.

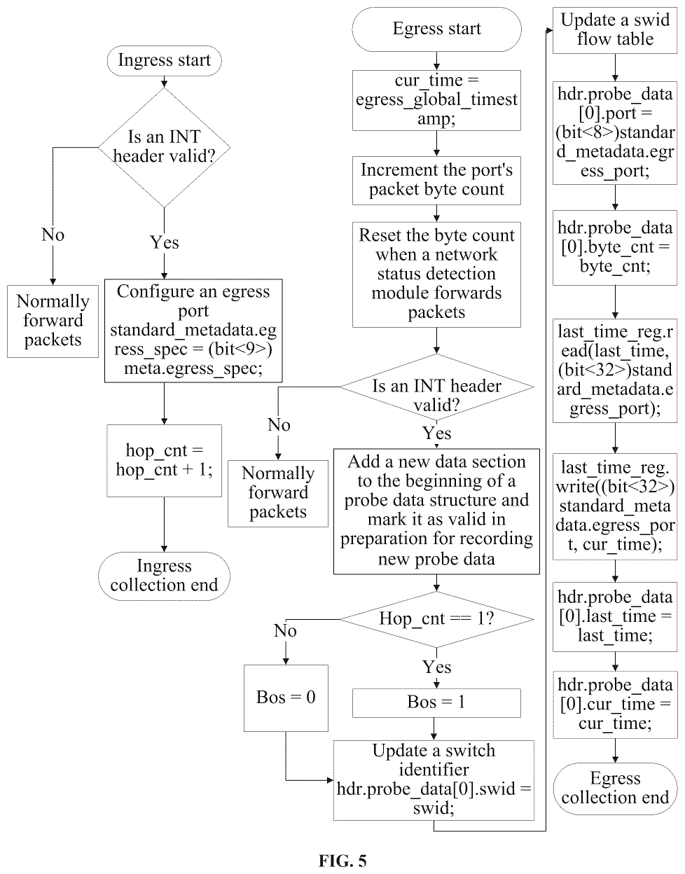

As shown in FIG. 5, the packet is in an ingress port handler of the switch. If the packet is a probe packet (determined through hdr.probe.isValido), the egress port of the probe packet is set to the egress_spec field in metadata and the count value of the hop counter for the probe packet increments. When the packet is in an egress port handler of the switch, a main function of the switch is to record data traffic of each port, and process and record information about the probe packet when necessary. In this part, a quantity of bytes in the packet and time information are recorded, and special logic of the probe packet is processed. First, the quantity of bytes in the packet and a current timestamp are obtained. Then, the timestamp and other information are inserted into a header of the packet, and the recorded quantity of bytes in the packet is updated. If the packet is a probe packet (determined through hdr.probe.isValido), the recorded quantity of bytes is reset, and a new data element is created in a probe data structure and marked as valid. It is set whether the data element is the first or last data element of probe data based on the hop count of the probe packet. A swid table is called to set a switch ID field. Other probe data fields are set, such as a port number, quantity of bytes, and timestamp. A recorded timestamp of the previous probe packet is updated.

Finally, the packet is sent to a deparser. All header fields are sent in reverse order to reconstruct the original packet. Each switch performs same operations. Finally, the receive end can obtain network status information in each switch supporting the network status detection module, including the latency, bandwidth, packet loss rate, and the like. For a switch in a hop, latency of each link is as follows:

$${RTT}_{i} = {cur\_time}_{i} - {last\_time}_{i} \qquad ( 1 )$$

cur_timeᵢ and last_timeᵢ are times when current and previous packets are received, respectively. A difference between them may be transmission latency of the link.

Throughput of each link is as follows:

$$B {W}_{i} = \frac{8. * byte cnti}{( cur\_timei - last\_timei )} \qquad ( 2 )$$

byte_cntᵢ is a quantity of bytes transmitted on the link. The throughput may be the quantity of bits transmitted on the link divided by the transmission latency of the link.

A packet loss rate may be calculated through a ratio of a quantity of packets received by the receive end to a quantity of packets sent by a previous-hop switch:

$$P {e}_{i} = \frac{{count\_rcv}_{i}}{{count\_snd}_{i}} \qquad ( 3 )$$

count_rcvᵢ and count_sndᵢ are the quantity of packets received by the receive end and the quantity of packets sent by the previous-hop switch, respectively.

### Network Coding Module

### (1) Network Coding Protocol Header

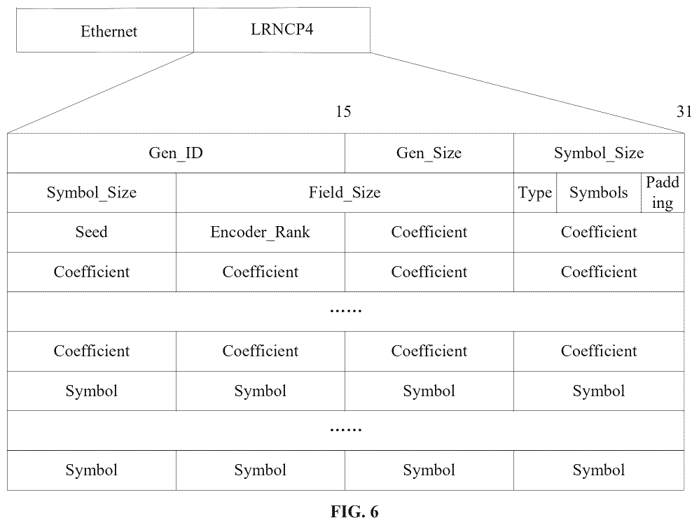

A header of a network encoded packet is mainly located after an Ethernet frame, as shown in FIG. 6. A main function of the header is to ensure a round to which the packet belongs, to ensure that the packet is correctly decoded and accepted. In addition, the receive end can obtain information such as bit counts and content of a payload and a encoding coefficient, a type of the packet, and a size of a finite field from the header of the packet.

Table 2 shows a detailed meaning and function of each field, including a quantity of bits in each field and its function. Defining the header of the network encoded packet makes it convenient for the programmable switch and its corresponding programming language P4 to modify a encoding vector and payload, and obtain a round of each group of packets, the bit count of the payload, the size of the finite field, and the like, and for the receive end to correctly receive and decode the packet.

TABLE 2
Meanings of network encoded packet header fields

| Network | | | |
|---|---|---|---|
| encoded packet | | Field | |
| header field | Position | length | Function |
| Gen_ID | Rlnc_out_t | 16 bit | Indicates a unique identifier of a round to which |
| | | | each packet belongs, ensuring that the receive end |
| | | | correctly receives and decodes the packet. |
| Gen_Size | Rlnc_out_t | 8 bit | Indicates a quantity of encoded packets in each |
| | | | round. In some encoding/decoding algorithms, |
| | | | packets are divided into different rounds for |
| | | | encoding and transmission. |
| Symbol_Size | Rlnc_out_t | 16 bit | Indicates a size of a symbol in network coding. In |
| | | | network coding, data is divided into symbols. Each |
| | | | symbol can be regarded as a smallest encoding unit. |
| Field_Size | Rlnc_out_t | 16 bit | Indicates a size of a finite field used in network |
| | | | coding. In network coding, encoding is performed |
| | | | over a finite field. The size of the finite field |
| | | | determines a range of numbers that can be used for |
| | | | encoding. |
| Type | Rlnc_in_t | 2 bit | Indicates a type of an input packet in network |
| | | | coding. If the type is 1, the packet is an original |
| | | | packet. If the type is 3, the packet is an encoded |
| | | | packet. |
| Symbols | Rlnc_in_t | 4 bit | Indicates a quantity of input symbols in network |
| | | | coding, namely a quantity of symbols involved in |
| | | | network coding information of the packet. |
| Padding | Rlnc_in_t | 2 bit | Indicates a padding bit used to pad a header to |
| | | | ensure that a total quantity of bits in a field is |
| | | | a multiple of 8. |
| seed | Rlnc_in_t | 8 bit | Indicates an initial value of a pseudorandom |
| | | | number generator configured to generate a |
| | | | encoding coefficient. |
| Encoder_Rank | Rlnc_in_t | 8 bit | Indicates a rank in a encoding matrix, which is a |
| | | | quantity of encoded symbols generated in network |
| | | | coding, to facilitate decoding at the receive end |
| | | | and help determine encoding efficiency and |
| | | | performance. |
| Cofficient | Coeffs_t | 8 bit | Indicates a coefficient of an encoding vector, |
| | | | with up to 100 fields. |
| Symbol | Symbols_t | 8 bit | Indicates a symbol in a payload of a packet, with |
| | | | up to 15 fields. |

### (2) Network Coding Parsing Module

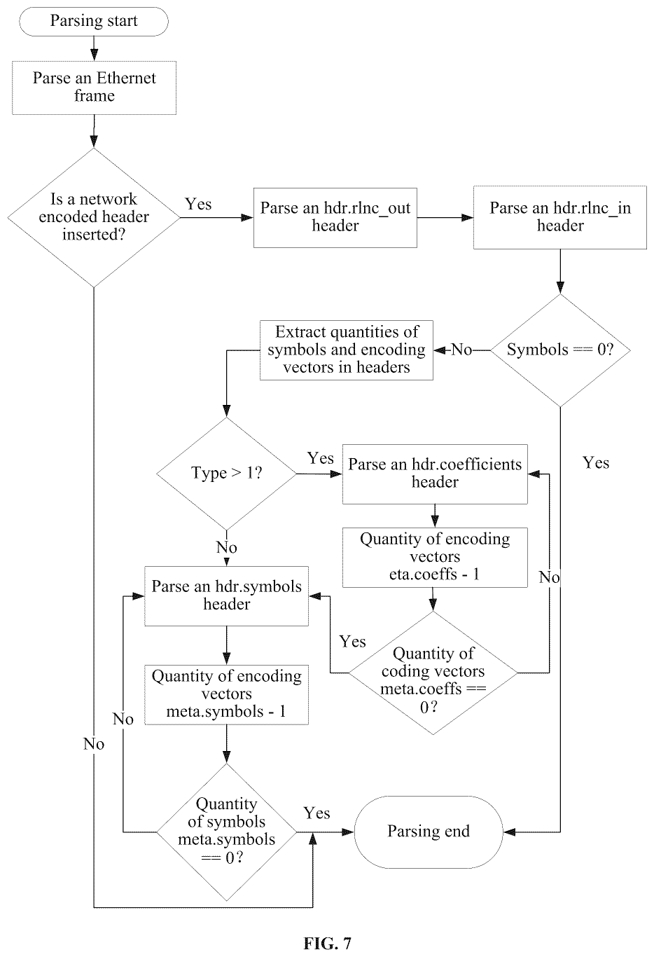

First, it is checked whether an Ethernet header exists. If a protocol of an encapsulated frame is a network encoded packet protocol, a network encoded header is verified and extracted based on a previously proposed format. If no network encoded header exists, a packet is not a network encoded packet and is immediately returned to a control ingress flow for multicast. A parsing technology used in the present application is unique in that a payload is divided into a plurality of symbols extracted into a plurality of headers (N symbols per header) rather than a single header. This is because in network coding, multiplication and addition used during encoding and decoding are performed over a finite field, and an excessively long payload cannot be computed. A header is needed to separately reference each group of symbols to correctly implement computations of a network coding scheme in a finite field during encoding. For example, if a Galois field (GF) is 2⁸ and a packet has 32 bits, their pkt.payload representation has 4 symbols (each with 8 bits). If a header contains one symbol, pkt.payload is extracted into 4 headers of the packet. FIG. 7 shows a specific parsing process.

### (3) Network Coding Buffer Module

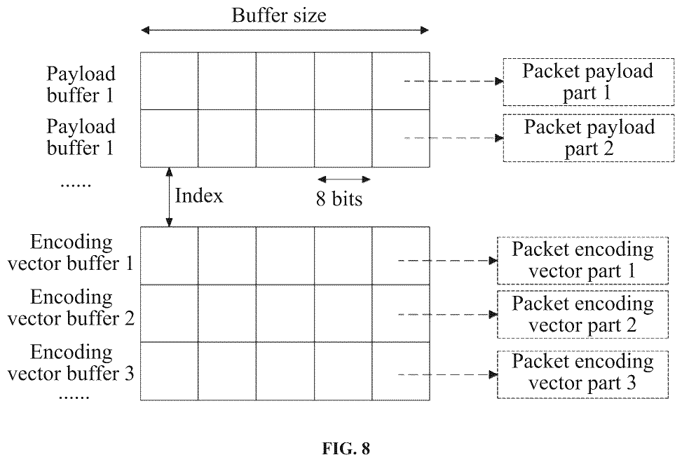

A buffer module for network encoded packets is configured to buffer packets with a network coding protocol to be transmitted by the transmit end. The packets are stored and used for subsequent encoding. To save memory for the buffer module, the buffer module maintains an identifier of a current round. Only packets in the current round can be buffered. As shown in FIG. 8, in the buffer module, considering that all computations on GF(2⁸) are computations on a finite field, 8 bits are needed to contain all computation results. Therefore, a payload of the packet and an encoding vector are divided into symbols that each have 8 bits and are stored in different buffers. The buffer module extracts data from each buffer for computations through an index.

### (4) Random Linear Network Coding Module

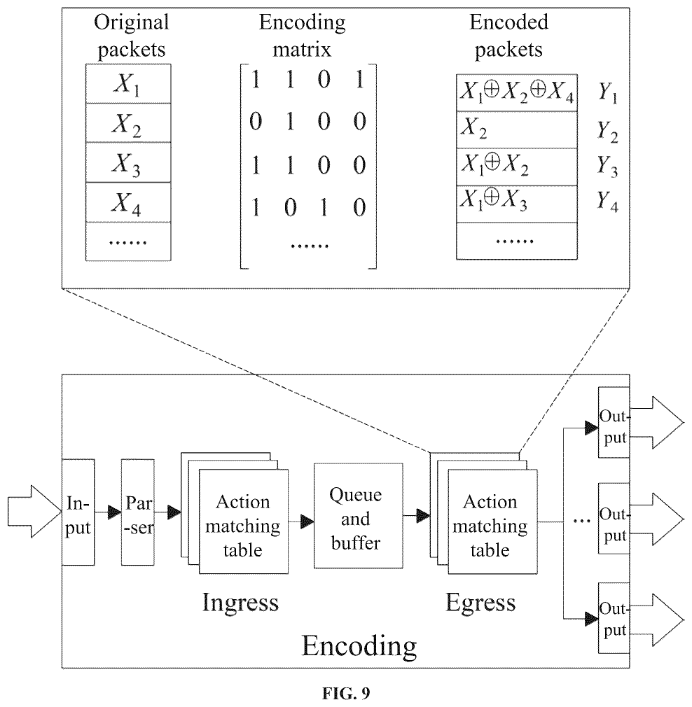

FIG. 9 is a schematic diagram of a network coding module and a cross-network converged scheduling module. A main procedure of the random linear network coding module is as follows: A programmable switch receives packets in a same round, parses them and processes them on an ingress port, and stores processed packets in the buffer module. Then, the packets are ready for network coding. If a size of the index is greater than or equal to a quantity of encoded packets in each round, the programmable switch has received enough packets for network coding. In this case, a packet in the buffer module is randomly selected as input and each symbol in a payload of the packet and content of an encoding vector are retrieved. During processing on an egress port, header content of the packet is replaced by randomly generating the encoding vector. A finite field is computed on an encoding vector matrix and the payload. Finally, a plurality of different encoded packets are generated through a multicast technology for decoding at the receive end.

Because large calculations cause buffer overflow, operations of the encoding module in the present application are limited to operations over finite fields. For arithmetic operations required in encoding, addition can be implemented through XOR. However, multiplication requires a logarithmic table and an antilogarithmic table to be maintained in advance. Multiplication of two numbers a and b may be changed to log a+log b. Then, a multiplication result of a and b can be obtained by calculating an antilogarithm of an obtained value. To accelerate processing of each packet, the programmable switch stores these pre-computed tables in a register during startup.

The following describes specific random linear network coding and decoding operations. Each time the switch codes a packet, a row vector of an encoding matrix is generated. The encoding matrix is as follows:

$$CM = [ \begin{matrix}{SM}_{K \times K} \\ {RM}_{( n - K ) \times K}\end{matrix} ] = [ \begin{matrix}{S}_{1 , 1} & {S}_{1 , 2} & … & {S}_{1 , K} \\ {S}_{2 , 1} & {S}_{2 , 2} & … & {S}_{2 , K} \\ ⋮ & ⋮ & ⋱ & ⋮ \\ {S}_{K , 1} & {S}_{K , 2} & … & {S}_{K , K} \\ {R}_{1 , 1} & {R}_{1 , 2} & … & {R}_{1 , K} \\ {R}_{2 , 1} & {R}_{2 , 2} & … & {R}_{2 , K} \\ ⋮ & ⋮ & ⋱ & ⋮ \\ {R}_{n - K , 1} & {R}_{n - K , 2} & … & {R}_{n - K , K}\end{matrix} ] \qquad ( 4 )$$

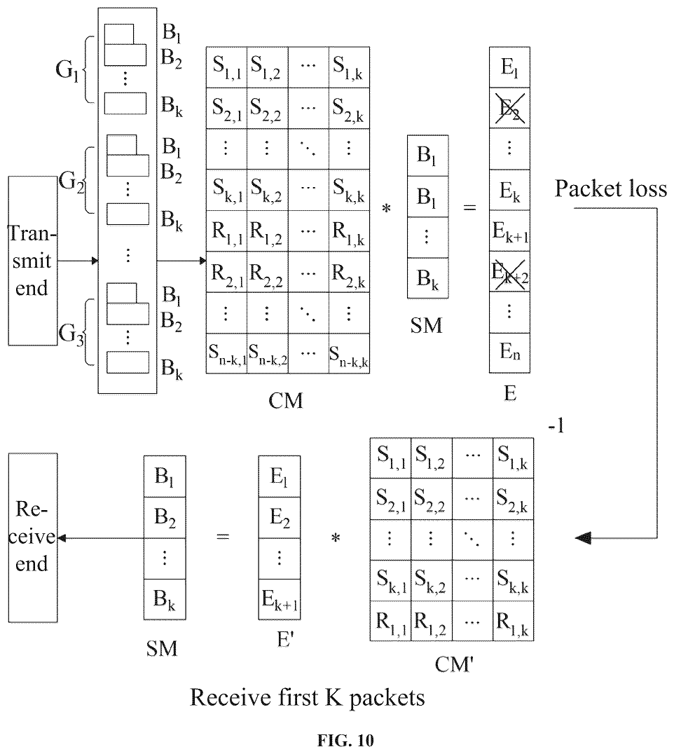

The encoding matrix CM consists of two parts: a vector matrix SM_{K×K} for encoding original packets and an added redundant encoding vector matrix RM_{(n-K)×K}. The encoding matrix CM consists of K column vectors. K is a quantity of original packets. n is a total quantity of packets in this round. n−K is a quantity of redundant packets introduced for a group of packets. All packets to be transmitted in a round can be obtained by calculating a product of the encoding vector matrix and the original packets. FIG. 10 intuitively shows a whole process of network coding at the transmit end, packet loss during transmission, and decoding at the receive end. In the figure, encoding is performed for any round. A row of row vectors in the encoding matrix CM is extracted and multiplied by the original packet. XOR processing is performed on all packets. The same operations are performed on each row to obtain encoded packets and redundant packets. During transmission, packet loss occurs due to link instability. The receive end cannot receive complete encoded packets. However, if a quantity of packets received by the receive end is greater than or equal to the quantity K of row vectors in the encoding matrix CM, an inverse of a matrix composed of the first K packets and their encoding coefficients is performed in the same way as encoding. In this way, the original packets are obtained through decoding.

### (5) Increased Throughput Network Coding Module

An intermediate node combines packets from different sources through binary XOR processing. The intermediate node waits a short time to encode received packets, to optimize an encoding advantage of the intermediate node. To minimize computational latency, packets that are not immediately decodable are discarded and only decodable packets are forwarded to a next hop. An objective of increased throughput network coding is to maximize a quantity of decodable packets on all N nodes with a same group of encoded packets.

Through multicast in a network, pure XOR encoding is performed on different packets to maximally transmit original packets in a single transmission and ensure that the receive end has supplementary packets to decode the original packets. If additional data is encoded and forwarded to a region in which no receiver can decode packets, additional computing resources are consumed and throughput is reduced. Therefore, an opportunistic encoding mechanism needs to ensure a decoding possibility. In addition, each node listens to packets it can receive and stores them for a period of time to decode the received encoded packets. It should be noted that packets from different flows may be encoded together on some intermediate nodes and decoded at a next-hop path fork. It is used by nodes to exchange information about packets owned by neighbors. A neighbor status provides information for intermediate nodes to decide whether to send encoded packets or only forward original packets.

In a header of an encoded packet, a round identifier increments by one each time a multicast encoded packet is transmitted. Gen_Size is set to a quantity of encoded packets on which XOR processing is performed. A size of a finite field is set to 2. A type is selected as an increased throughput network coding module. No encoding coefficient vector part is added. The rest is the same as that of a header for random linear encoding. The receive end decodes the received encoded packet based on the type of the received packet and packets stored in a buffer. If immediate decoding cannot be performed, the packet is immediately discarded to minimize computational latency.

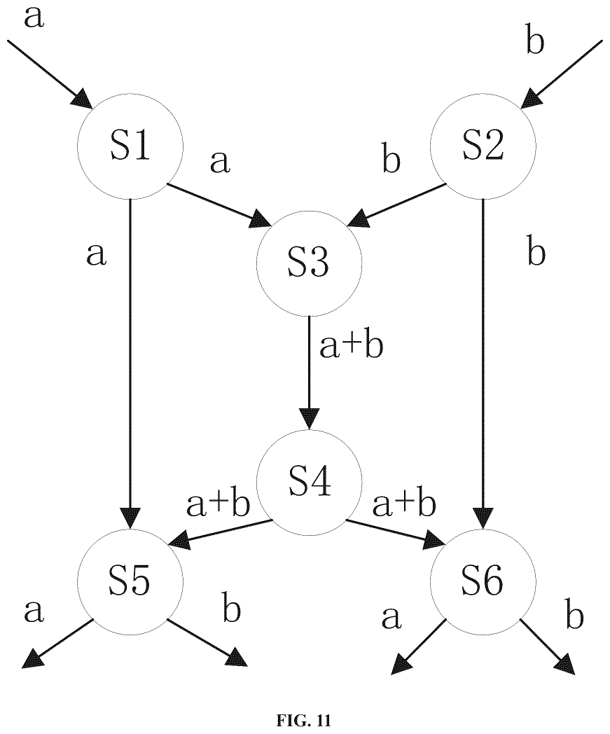

FIG. 11 is a schematic diagram of increased throughput network coding. It can be learned that when a switch S3 transmits packets, data transmission can be carried out by transmitting only one packet through encoding in comparison with a traditional way of transmitting two packets. This indirectly increases throughput during data transmission and ensures low latency during video stream transmission.

### (6) Encoding Redundancy Adjustment Module

Coding redundancy is adjusted to minimize additional latency due to random linear network coding, to meet requirements of communication applications. Specifically, encoding latency is characterized first. A quantity of original packets transmitted in each round is sw. The encoding redundancy is R. A total quantity of packets transmitted in each round is m=┌sw/(1−R)┐. An encoding window of this round is cw=┌m*R┐. A length of each packet is n bits. A transmission rate is f₁ bps. Transmission latency is as follows:

$${T}_{t} = ( cw \times n ) / f 1 \qquad ( 5 )$$

Generally, generating an encoded packet requires sw×n multiplications and (sw−1)×n additions in a Galois field. A rate of performing a finite field calculation is f₂ bps. Based on the foregoing process, packet encoding latency is as follows:

$${T}_{e} = [ ( 2 \times sw - 1 ) \times cw \times n ] / {f}_{2} \qquad ( 6 )$$

In a classical linear network coding process, if m packets are transmitted and a quantity of lost packets is less than cw, decoding can be performed; otherwise, decoding cannot be performed and an encoding retransmission strategy needs to be triggered. Therefore, decoding latency may be as follows:

$${T}_{d} = {\sum }_{i = 1}^{CW} ( \begin{matrix}m \\ i\end{matrix} ) {( 1 - Pe )}^{m - i} {Pe}^{i} \times + {\sum }_{i = cw + 1}^{m} ( \begin{matrix}m \\ i\end{matrix} ) {( 1 - Pe )}^{m - i} {Pe}^{i} \times {RTT}_{X} \qquad ( 7 )$$

The former term is decoding latency when the packets can reach the receive end. The latter term is decoding latency until next retransmission starts when the packets cannot reach the receive end. Pe is a packet loss rate of a link. Because an inverse matrix of a matrix is solved through lower-upper (LU) decomposition in the present application, time complexity is O(n³). [symbol] =F(•) is latency for decoding encoded packets in a round, which is related to a size of the matrix.

Considering requirements for real-time and reliable video streams during remote driving, the present application minimizes the encoding latency, decoding latency, and transmission latency during network coding. An optimization objective of a model is as follows:

$$\begin{matrix}minimize & T = {T}_{t} + {T}_{e} + {T}_{d}\end{matrix} \qquad ( 8 )$$

$$subject to \qquad C 1 : R \geq Pe$$

$$C 2 : {K}_{s n d} + \frac{s w}{1 - R} \leq {F}_{s n d}$$

$$C 3 : {K}_{r c v} + s w \leq {F}_{r c v}$$

A constraint C1 ensures that the encoding redundancy is not less than the packet loss rate such that the transmitted packets can be maximally repaired at the receive end. A constraint C2 ensures that a buffer capacity F_{snd} at the transmit end is not less than a total quantity

$${K}_{s n d} + \frac{s w}{1 - R}$$

of packets transmitted in this round and a next round. A constraint C3 ensures that a buffer capacity F_{rcv} at the receive end is not less than a total quantity K_{rcv}+sw of packets arriving in this round and the next round.

### Cross-Network Converged Scheduling Module

For a link latency estimation and adjustment module, transmission latency, propagation latency, processing latency, and queuing latency are involved. Because the transmission latency is considered by the network coding module, and the processing latency and the queuing latency are very small compared with the propagation latency, this module considers only estimation and adjustment of the propagation latency. In a real network environment, latency may fluctuate or have noises instantaneously due to network congestion, routing changes, or other factors. These instantaneous noises can be smoothed through exponentially weighted moving average to make average latency more stable. This is significant for application scenarios such as real-time video streams that require stable latency. Therefore, a latency estimation formula for the cross-network converged scheduling module is as follows:

$$R T {T}_{i} = α {RTT}_{i}^{pre} + ( 1 - α ) {RTT}_{i}^{now} \qquad ( 9 )$$

RTTᵢ is smoothed latency in a current measurement.

$$R T {T}_{i}^{p r e}$$

is smoothed latency in a previous measurement.

$$R T {T}_{i}^{n o w}$$

is original latency in the current measurement. A purpose is to smooth the latency to reduce impact of random fluctuation and instantaneous noises such that measurement results are more stable and reliable. The parameter α in the formula can be used to adjust weights of a current measurement value and last smoothed latency. This can make smoothed results more flexible to adapt to changes in a network. A large α value makes for a stronger dependence on historical data, suitable for slow network changes. A small α value reflects changes in latest measurement values more quickly, suitable for frequent network changes.

The cross-network converged scheduling module needs to estimate a packet loss rate because the packet loss rate is one of important metrics for evaluating network link quality. For cross-network converged scheduling, knowing a packet loss rate of each path can help a system make more appropriate path selection and scheduling decisions. Because a network environment is dynamic, link quality is affected by a plurality of factors, such as network congestion, routing changes, and signal interference. A packet loss rate of a link is usually random and fluctuant. Temporary packet loss may occur even in a short time. Consequently, the packet loss rate at a single moment may not accurately reflect true quality of the link. Measurements of the packet loss rate usually depend on packet information collected from a network device or a protocol. However, due to network latency, device processing time, or another factor, packet loss may be delayed or missed during the measurements, resulting in an inaccurately estimated packet loss rate at a current moment. In addition, a packet loss rate measured at a specific moment cannot cope with some unexpected situations. Therefore, this module measures the packet loss rate for a period of time to make changes in the packet loss rate not too rapid and ensure measurement accuracy. Therefore, the packet loss rate for a period of time may be as follows:

$$P {e}_{i}^{N} = \frac{L o s s N u {m}_{i}^{N}}{s e {q}_{e n d}^{N} - s e {q}_{s t a r t}^{N} + 1} \qquad ( 10 )$$

$$P {e}_{i}^{N}$$

is a packet loss rate of an i^{th} link in an N^{th} measurement.

$$L o s s N u {m}_{i}^{N}$$

is a quantity of packets lost on the i^{th} link in the N^{th} measurement.

$$s e {q}_{e n d}^{N} and {seq}_{start}^{N}$$

are end and start packet sequence numbers on the i^{th} link in the N^{th} measurement, respectively. Packet sequence numbers within this measurement period are usually consecutive. Formula (10) is to divide the quantity of lost packets by a total quantity of transmitted packets to obtain the packet loss rate in this period.

The packet loss rate obtained is used to update and estimate a packet loss rate state of the link at a next moment. The estimated packet loss rate of the link is replaced by an average packet loss rate measured in each period during the running time of the cross-network converged scheduling module. A specific formula is as follows:

$${Pe}_{i} = \frac{{\sum }_{0}^{m} ( {Pe}_{i}^{N} \times {count}_{i}^{N} )}{{\sum }_{0}^{m} {count}_{i}^{N}} \qquad ( 11 )$$

Peᵢ is an average packet loss rate of the i^{th} link.

$${count}_{i}^{N}$$

is a total quantity of packets on the i^{th} link in the N^{th} measurement. This calculation method ensures that when the packet loss rate is estimated, if a large quantity of packets is transmitted, the measured packet loss rate accounts for a larger proportion of the average packet loss rate such that the measured packet loss rate of the link is more accurate.

Finally, for a link bandwidth measurement and adjustment module, a network detection module can measure only a transmission rate of the link. Bandwidth of the link can be measured only when the link is full of measurement traffic. However, this cannot enable the whole system to perform normal network coding and forwarding operations. Therefore, the present application indirectly measures the bandwidth of the link by measuring the link latency. When load balancing is implemented, that is, throughput is maximized, the latency of each link does not differ greatly. Therefore, if a latency difference between links does not exceed a threshold, the estimated bandwidth of the link is correct. If the latency difference between the links exceeds the threshold, the link bandwidth needs to be updated. A formula for updating predicted link bandwidth is as follows:

$$B {W}_{i} = \{ \begin{matrix}B {W}_{i}^{p r e} , Δ RTT \leq Threshold \\ B {W}_{i}^{p r e} + B {W}_{i}^{p r e} \times ( {T}_{i}^{p r e} − \frac{R T {T}_{i}^{now}}{2} ) \times {e}^{− β} , Δ RTT > Threshold\end{matrix} \qquad ( 12 )$$

BWᵢ is bandwidth of the i^{th} link at a current moment.

$$B {W}_{i}^{p r e}$$

is bandwidth of the i^{th} link at a previous moment. ΔRTT is a latency difference between two links. Threshold is a specified latency difference threshold. β is a parameter controlling a bandwidth adjustment rate.

$${T}_{i}^{p r e}$$

is average latency obtained in a previous measurement. Formula (12) adjusts the bandwidth of the link by decreasing the estimated bandwidth of the link if the estimated latency of the link is less than latency obtained in a current measurement; otherwise, increasing the estimated bandwidth of the link.

Finally, the cross-network converged scheduling module can determine the weight of each path based on bandwidth, round-trip latency, and packet loss rates of different paths through a weight calculation method, to adjust a quantity of packets transmitted on the path and implement load balancing. Larger bandwidth, a smaller packet loss rate, and lower latency of the link indicate a larger weight of the link. Therefore, a link weight adjustment formula for the cross-network converged scheduling module is as follows:

$${weight}_{i} = \frac{α {BW}_{i}}{β {RTT}_{i} ⋆ γ {Pe}_{i}} \qquad ( 13 )$$

weightᵢ is a weight of the i^{th} link. RTTᵢ, BWᵢ, and Peᵢ are the latency, bandwidth, and packet loss rate of the i^{th} link, respectively. α, β, and γ are used to adjust impact of the bandwidth, round-trip latency, and packet loss rate on the weight, respectively.

In the present application, random linear or increased throughput network coding is performed based on an application type of packets to be transmitted. Random linear network coding automatically adjusts encoding redundancy based on link status information, such as latency and bandwidth. Original packets are recovered through redundant packet decoding at the receive end. Link reliability is improved. In addition, retransmission latency required for packet loss retransmission due to link instability is reduced. Increased throughput network coding mainly ensures low latency of link transmission by maximizing a quantity of transmitted packets in a transmission process. By utilizing programmability of a programmable switch, a data plane can be reconfigured during packet forwarding by the switch. This makes it possible to construct a network coding data plane with high performance and production quality. In addition, a chip of the programmable switch can process billions of packets per second, which is several orders of magnitude higher than throughput of an existing network coding solution. Use of a protocol-independent packet processor programming language and an increase in a quantity of available compilers make a program increasingly portable across different software and hardware devices. The network status detection module is provided, which mainly allows fine-grained monitoring of network traffic, enabling the module to collect data at various points within a network, including an individual switch and router. This module constructs and parses a network status detection packet to sense a network status only through a few packets. The protocol construction and parsing modules implement network status detection, network coding, and the like by constructing and parsing different protocol packets, and add other packet formats to implement other functions on an original basis, reflecting compatibility of the method. The network coding buffer module buffers the packets in the current round, performs computations on the GF(2\hat{ }8) finite field, and divides the payload of the packet and the encoding vector into 8-bit symbols and stores the symbols in different buffers. If the index size is less than the buffer size, the packet is stored and the index increments. Otherwise, a randomly selected column is overwritten until a next round of encoding. For the encoding method selection module, because large calculations cause buffer overflow, operations of the encoding module are limited to operations over finite fields. For finite field multiplication, a logarithmic table and an antilogarithmic table need to be maintained in advance. Multiplication of two numbers a and b may be changed to log a+log b. Then, a multiplication result of a and b can be obtained by calculating an antilogarithm of an obtained value. To accelerate processing of each packet, the programmable switch stores these pre-computed tables in a register during startup. An inverse matrix of a matrix is solved through LU decomposition to reduce decoding complexity of the receive end. Different encoding methods are selected for different application types. If an application requires low latency and is suitable for a multicast scenario, the increased throughput network coding method is used. If the application requires high reliability, the random linear network coding method is used. The forwarding module is configured to multicast network encoded packets and perform control on an egress port for several times to encode row vectors of each encoding vector matrix and original packets in network coding. The redundancy adjustment module adjusts encoding redundancy to minimize network coding latency. Transmission in an encoding fault tolerance process is characterized based on a quantity of redundant packets. Coupling correlation of factors such as encoding redundancy and encoding and decoding latency is quantified. A cross-network fusion latency-reliability coupling control method and joint optimization encoding model under transmission reliability constraints are designed. The weight adjustment module and the scheduling forwarding module estimate a network status at a next moment based on the link status sensed by the network status detection module, adjust a proportion of packets transmitted on each link as a weight based on the estimated network status, and finally transmit a corresponding quantity of packets based on the adjusted weight of each link. A data plane can be reconfigured during packet forwarding by the switch. This makes it possible to construct a network coding data plane with high performance and production quality. In addition, a chip of the programmable switch can process billions of packets per second, which is several orders of magnitude higher than throughput of an existing network coding solution. Use of a protocol-independent packet processor programming language and an increase in a quantity of available compilers make a program increasingly portable across different software and hardware devices. An INT technology collects and reports a network status directly from the data plane, providing end-to-end packet-level network status information with finer granularity and lower latency. To improve performance of the apparatus in the present disclosure, in the random linear network coding module, the encoding redundancy is adjusted to minimize the network coding latency. In the random linear network decoding module, decoding complexity is reduced by optimizing decoding. In the increased throughput network coding method, throughput is increased by maximizing a quantity of packets transmitted in one transmission. In addition, computational latency is reduced by discarding packets that cannot be decoded immediately in a decoding process. In the cross-network converged scheduling module, an optimal path is selected for scheduling based on detected network status information, to ensure that the packets are transmitted to the receive end fastest. Different encoding methods are used based on application types such that the encoding method is more flexible based on transmission requirements of applications, and data transmission requirements of each application are effectively met.

In the present application, it can be ensured that when operating to a dead zone of a cellular network during transmission between a vehicle and a cloud, an application in the Internet of vehicles, such as remote driving or remote medical diagnosis, can still carry out reliable communication through another operator's cellular network or the like, without being affected by signal loss and the like. In addition, network coding ensures that various types of applications can implement low-latency or high-reliability transmission. During remote driving, a video stream captured by a transmission device such as a high-definition camera needs to be transmitted to the cloud quickly in real time through the apparatus for cross-network converged transmission based on network coding in the present disclosure. This transmission method ensures that a remote driver can timely obtain real-time environmental information around the vehicle to make accurate remote control and decisions. The application has a strict latency requirement, but can tolerate some packet loss. Therefore, through increased throughput network coding, different source packets are combined and packets that are not immediately decodable are discarded. This increases throughput and reduces latency during transmission of data from each vehicle to different remote driving platforms. During remote diagnosis and medical treatment, a high-definition view inside an ambulance and vital sign data of a patient are transmitted to the cloud quickly in real time such that a medical professional can remotely conduct real-time guidance and emergency treatment for emergency personnel. The high-definition view of the patient's injury and vital sign data of the patient require absolute reliability to ensure clarity of the view. Therefore, random linear network coding is adopted to ensure transmission reliability, and encoding and decoding performance is improved by optimizing an encoding and decoding method.

In the present application, applications of an unmanned aerial vehicle (UAV) can be guaranteed. It can be ensured that the UAV is continuously within a coverage range of network signals in a flight process through cross-network convergence. Latency and reliability requirements of various applications are met through network coding. There is a very strict latency requirement in disaster relief missions because every minute after a disaster can be critical to life. In a disaster scene, real-time information needs to be obtained, including disaster situations, survivor positions, traffic conditions, and the like. When survivors or emergency situations are found, rescue operations need to be quickly performed to respond. Therefore, data information needs to be transmitted in time for each UAV, and the increased throughput network coding method is adopted to ensure low-latency transmission of applications. During aerial photography, to ensure that an aerial image has high resolution and good clarity to capture details and features of a captured region, and accurately restore true colors and the like of a captured scene, data of the transmitted image needs to be highly reliable. Therefore, transmission reliability is ensured through random linear encoding.

### Embodiment 2

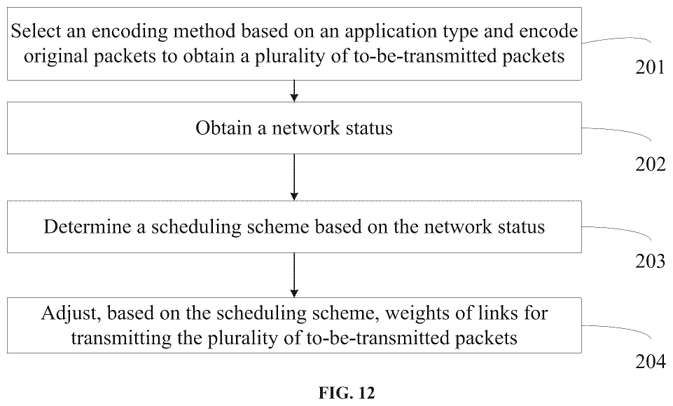

As shown in FIG. 12, this embodiment discloses a method for cross-network converged transmission based on network coding, including:

Step 201: Select an encoding method based on an application type and encode original packets to obtain a plurality of to-be-transmitted packets. The to-be-transmitted packets include encoded packets and redundant packets.

Step 202: Obtain a network status.

Step 203: Determine a scheduling scheme based on the network status.

Step 204: Adjust, based on the scheduling scheme, weights of links for transmitting the plurality of to-be-transmitted packets.

Step 201 includes: When the application type is oriented toward a scenario that guarantees reliability for a service, data, and transmission, encode the original packets through a random linear network coding method in an end-to-end transmission or multicast scenario; when the application type is oriented toward a scenario that guarantees low latency for a service, data, and transmission, encode the original packets through an increased throughput network coding method in a multicast scenario; or skipping performing network coding in an end-to-end transmission scenario.

The random linear network coding method includes: initializing a rank of an encoding vector matrix to 0; randomly generating a current encoding row vector and increasing the rank of the encoding vector matrix by 1; multiplying the current encoding row vector by each original packet; performing XOR processing on all original packets after the multiplication operation to obtain encoded packets corresponding to the current encoding row vector; determining, based on the rank of the encoding vector matrix, whether the encoding vector matrix is a square matrix; and if the encoding vector matrix is not a square matrix, returning to the step of randomly generating the current encoding row vector and increasing the rank of the encoding vector matrix by 1; or if the encoding vector matrix is a square matrix, generating a current redundant row vector based on redundancy, multiplying the current redundant row vector by each original packet, and performing XOR processing on all original packets after the multiplication operation to obtain redundant packets corresponding to the current redundant row vector until a quantity of redundant packets reaches a preset quantity of redundant packets.

A decoding method corresponding to the random linear network coding method includes: determining that all packets received within a time threshold are packets received in a current round; obtaining a quantity of the packets received in the current round as a first quantity; obtaining a quantity of packets transmitted by a transmit end in the current round as a second quantity; and when the first quantity is greater than or equal to the second quantity, obtaining, based on a receiving sequence of a receive end, the first K packets received in the current round, to construct an inverse matrix of an encoding square matrix, and performing a multiplication-XOR operation on the inverse matrix of the encoding square matrix to obtain the original packets; or when the first quantity is less than the second quantity, retransmitting the to-be-transmitted packets.

The increased throughput network coding method includes: determining any intermediate node as a current node; when the current node receives source packets sent by a plurality of source nodes, encoding the plurality of source packets to obtain an intermediate packet; when a quantity of destination nodes of the current node is 1, transmitting the intermediate packet to the destination node; using the destination node as the current node and returning to the step of transmitting the intermediate packet to the destination node when the quantity of destination nodes of the current node is 1 until the quantity of destination nodes of the current node is greater than 1; when the quantity of destination nodes of the current node is greater than 1, decoding the intermediate packet into the plurality of source packets; and sending all source packets to each destination node.

The scheduling scheme is as follows:

$${weight}_{i} = \frac{α {BW}_{i}}{β {RTT}_{i} * γ {Pe}_{i}}$$

where weightᵢ is the weight of the i^{th} link, a is an adjustment to impact of bandwidth on the weight, BWᵢ is bandwidth of the i^{th} link at a current moment, β is an adjustment to impact of round-trip latency on the weight, RTTᵢ is round-trip latency of the i^{th} link at the current moment, γ is an adjustment to impact of a packet loss rate on the weight, and Peᵢ is an average packet loss rate of the i^{th} link at the current moment.

$$B {W}_{i} = \{ \begin{matrix}B {W}_{i}^{p r e} , Δ RTT \leq Threshold \\ B {W}_{i}^{p r e} + B {W}_{i}^{p r e} \times ( {T}_{i}^{p r e} − \frac{R T {T}_{i}^{now}}{2} ) \times {e}^{− β} , Δ RTT > Threshold\end{matrix}$$

where BW

$$B {W}_{i}^{p r e}$$

is bandwidth of the i^{th} link at a previous moment, ΔRTT is a latency difference between two links, Threshold is a preset latency difference threshold,

$${T}_{i}^{p r e}$$

is average latency obtained in a previous measurement, and

$$R T {T}_{i}^{n o w}$$

is original latency in a current measurement.

$${RTT}_{i} = α {RTT}_{i}^{pre} + ( 1 - α ) {RTT}_{i}^{now}$$

where

$${RTT}_{i}^{pre}$$

is smoothed latency obtained in the previous measurement.

$${Pe}_{i} = \frac{{\sum }_{0}^{m} ( {Pe}_{i}^{N} \times {count}_{i}^{N} )}{{\sum }_{0}^{m} {count}_{i}^{N}}$$

where

$${Pe}_{i}^{N}$$

is a packet loss rate of the i^{th} link in an N^{th} measurement,

$${count}_{i}^{N}$$

is a total quantity of packets on the i^{th} link in the N^{th} measurement, and m is a total quantity of measurements of the packet loss rate.

In the present application, the network status detection module is added to sense the link status. Status information is transmitted to the cross-network converged scheduling module to adjust the link status. An optimal link path is selected for transmission. A network coding technology is applied to a programmable switch. A possibility that network coding is applied to an entity switch is increased. Different encoding and decoding methods are selected based on application types. This reduces network coding and decoding complexity and transmission latency.

What is claimed is:

1. A method for cross-network converged transmission based on network coding, comprising:
selecting an encoding method based on an application type and encoding original packets to obtain a plurality of to-be-transmitted packets, wherein the to-be-transmitted packets comprise encoded packets and redundant packets;
obtaining a network status;
determining a scheduling scheme based on the network status; and
adjusting, based on the scheduling scheme, weights of links for transmitting the plurality of to-be-transmitted packets.

2. The method for cross-network converged transmission based on network coding according to claim 1, wherein the selecting an encoding method based on an application type and encoding original packets to obtain a plurality of to-be-transmitted packets comprises:
when the application type is oriented toward a scenario that guarantees reliability for a service, data, and transmission, encoding the original packets through a random linear network coding method in an end-to-end transmission or multicast scenario;
when the application type is oriented toward a scenario that guarantees low latency for a service, data, and transmission, encoding the original packets through an increased throughput network coding method in a multicast scenario; or
skipping performing network coding in an end-to-end transmission scenario.

3. The method for cross-network converged transmission based on network coding according to claim 2, wherein the random linear network coding method comprises:
initializing a rank of an encoding vector matrix to 0;
randomly generating a current encoding row vector and increasing the rank of the encoding vector matrix by 1;
multiplying the current encoding row vector by each original packet; and performing exclusive OR (XOR) processing on all original packets after the multiplication operation to obtain encoded packets corresponding to the current encoding row vector;
determining, based on the rank of the encoding vector matrix, whether the encoding vector matrix is a square matrix; and
if the encoding vector matrix is not a square matrix, returning to the step of randomly generating the current encoding row vector and increasing the rank of the encoding vector matrix by 1; or
if the encoding vector matrix is a square matrix, generating a current redundant row vector based on redundancy; and
multiplying the current redundant row vector by each original packet; and performing XOR processing on all original packets after the multiplication operation to obtain redundant packets corresponding to the current redundant row vector until a quantity of redundant packets reaches a preset quantity of redundant packets.

4. The method for cross-network converged transmission based on network coding according to claim 3, wherein a decoding method corresponding to the random linear network coding method comprises:
determining that all packets received within a time threshold are packets received in a current round;
obtaining a quantity of the packets received in the current round as a first quantity;
obtaining a quantity of packets transmitted by a transmit end in the current round as a second quantity; and
when the first quantity is greater than or equal to the second quantity, obtaining, based on a receiving sequence of a receive end, the first K packets received in the current round, to construct an inverse matrix of an encoding square matrix; and
performing a multiplication-XOR operation on the inverse matrix of the encoding square matrix to obtain the original packets; or
when the first quantity is less than the second quantity, retransmitting the to-be-transmitted packets.

5. The method for cross-network converged transmission based on network coding according to claim 2, wherein the increased throughput network coding method comprises:
determining any intermediate node as a current node;
when the current node receives source packets sent by a plurality of source nodes, encoding the plurality of source packets to obtain an intermediate packet;
when a quantity of destination nodes of the current node is 1, transmitting the intermediate packet to the destination node;
using the destination node as the current node and returning to the step of transmitting the intermediate packet to the destination node when the quantity of destination nodes of the current node is 1 until the quantity of destination nodes of the current node is greater than 1;
when the quantity of destination nodes of the current node is greater than 1, decoding the intermediate packet into the plurality of source packets; and
sending all source packets to each destination node.

6. The method for cross-network converged transmission based on network coding according to claim 2, wherein the scheduling scheme is as follows:
$${weight}_{i} = \frac{α {BW}_{i}}{β {RTT}_{i} * γ {Pe}_{i}}$$
wherein weightᵢ is the weight of the i^{th} link, α is an adjustment to impact of bandwidth on the weight, BWᵢ is bandwidth of the i^{th} link at a current moment, β is an adjustment to impact of round-trip latency on the weight, RTTᵢ is round-trip latency of the i^{th} link at the current moment, γ is an adjustment to impact of a packet loss rate on the weight, and Peᵢ is an average packet loss rate of the i^{th} link at the current moment.

7. The method for cross-network converged transmission based on network coding according to claim 6, wherein the bandwidth of the i^{th} link at the current moment is as follows:
$${BW}_{i} = \{ \begin{matrix}{BW}_{i}^{pre} , & Δ RTT \leq Threshold \\ {BW}_{i}^{pre} + {BW}_{i}^{pre} \times ( {T}_{i}^{pre} - \frac{{RTT}_{i}^{now}}{2} ) \times {e}^{- β} , & Δ RTT > Threshold\end{matrix}$$
wherein
$${BW}_{i}^{pre}$$
is bandwidth of the i^{th} link at a previous moment, ΔRTT is a latency difference between two links, Threshold is a preset latency difference threshold,
$${T}_{i}^{pre}$$
is average latency obtained in a previous measurement, and
$${RTT}_{i}^{now}$$
is original latency in a current measurement.

8. The method for cross-network converged transmission based on network coding according to claim 7, wherein the round-trip latency of the i^{th} link at the current moment is as follows:
$${RTT}_{i} = α {RTT}_{i}^{pre} + ( 1 - α ) {RTT}_{i}^{now}$$
wherein
$${RTT}_{i}^{pre}$$
is smoothed latency obtained in the previous measurement.

9. The method for cross-network converged transmission based on network coding according to claim 8, wherein the average packet loss rate of the i^{th} link at the current moment is as follows:
$${Pe}_{i} = \frac{{\sum }_{0}^{m} ( {Pe}_{i}^{N} \times {count}_{i}^{N} )}{{\sum }_{0}^{m} {count}_{i}^{N}}$$
wherein
$${Pe}_{i}^{N}$$
is a packet loss rate of the i^{th} link in an N^{th} measurement,
$${count}_{i}^{N}$$
is a total quantity of packets on the i^{th} link in the N^{th} measurement, and m is a total quantity of measurements of the packet loss rate.

10. An apparatus for cross-network converged transmission based on network coding, wherein the apparatus is applied to a smart city system; the smart city system includes a transmit end and a receive end; and the transmit end transmits a plurality of to-be-transmitted packets to the receive end through a plurality of links;
the apparatus comprises:
a network status detection module configured to obtain a network status,
a network coding module configured to select an encoding method based on an application type and encode original packets to obtain a plurality of to-be-transmitted packets, and
a cross-network converged scheduling module that are integrated at the transmit end;
the cross-network converged scheduling module is connected to the network status detection module and the network coding module and is configured to determine a scheduling scheme based on the network status, and adjust, based on the scheduling scheme, weights of links for transmitting the plurality of to-be-transmitted packets;
the network coding module comprises, sequentially connected:
a protocol construction module,
a redundancy adjustment module,
an encoding method selection module, and
a parsing module,
a buffer module,
an encoding module, the protocol construction module, the redundancy adjustment module, and the encoding method selection module each being connected to the encoding module; and
a forwarding module;
the cross-network converged scheduling module comprises a weight adjustment module connected to the network status detection module and a forwarding scheduling module, the forwarding scheduling module being connected to the forwarding module and the weight adjustment module.
